(19) United States
(12) Patent Application Publication
(10) Pub. No.: US 2009/0101102 A1
(43) Pub. Date: Apr. 23, 2009

(54) Compact Output Speed Reduction System

(76) Inventor: Timothy Bishop, Northants (GB)

Correspondence Address: AMSTER, ROTHSTEIN & EBENSTEIN LLP, 90 PARK AVENUE, NEW YORK, NY, 10016, US

(21) Appl. No.: 11/793,534

(22) PCT Filed: Dec. 22, 2005
(86) PCT No.: PCT/GB2005/005044

§ 371 Date: May 25, 2008

(30) Foreign Application Priority Data
Dec. 22, 2004 (GB) 0428089.7

(51) Int. Cl. F16D 31/04; F01M 1/06

(52) U.S. Cl. 123/198 C; 192/61; 184/27.1

(57) ABSTRACT

An appliance set comprising an appliance for receiving a rotational drive at an input shaft; an internal combustion engine having a crankshaft and an oil pump having at least one gear driven from the crankshaft; and a coupling that mechanically couples the input shaft to the said gear whereby the appliance can be driven from the gear of the oil pump.

The present invention relates to an output arrangement whereby drive can be taken from an engine. More particularly it preferably relates to an output speed reduction system that can be realised in a compact manner, and especially to a compact output speed reduction system for use with an internal combustion engine.

The oil-pump is an integral part of any internal combustion engine. Pumping and generator sets are generally designed to operate at rotational speeds of around 2000 to 2500 rpm. This matches the torque and revolution characteristics of a diesel engine but not those of a petrol unit. However, diesel engines are heavy, noisy, dirty and cumbersome and require large and powerful starting equipment.

Therefore there is a need to match the speed and torque output characteristics of a lightweight, clean and quiet petrol engine to the standard characteristics of currently available pumps and generators. This could be done by means of conventional gearing, but that would occupy space and so could hinder the attachment of an engine to the appliance that is desired to be driven. It is also inefficient and adds weight and cost.

Modern engine oil-pumps are often concentric devices mounted around the nose of the crankshaft. Typically, a large internally toothed gear is driven by a smaller externally toothed gear mounted within it and driven directly by the crankshaft. A stationary crescent-shaped piece of material fitted between the gears confines the oil to the region where the teeth intermesh, or to pockets otherwise formed in the large gear. The oil is thereby forced to flow by the rotating motion of the large gear. The larger gear, by the nature of the interaction between it and the small gear mounted on the crankshaft, rotates at a slower speed that the crankshaft.

There is a need for an alternative form of output from an engine, and preferably a form that can allow an output speed reduction to be obtained in a relatively compact manner.

According to the present Invention there is provided an appliance set comprising: an appliance for receiving a rotational drive at an input shaft; an internal combustion engine having a crankshaft and an oil pump having at least one gear driven from the crankshaft; and a coupling that mechanically couples the input shaft to the said gear whereby the appliance can be driven from the gear of the oil pump.

The present invention also provides an appliance, such as a pump or vehicle, powered by an internal combustion engine, the engine having a crankshaft and an oil pump having two or more gears coupled to the crankshaft, the appliance being driven by one of the gears of the oil pump.

Further advantageous features are disclosed in the dependent claims.

Thus, if the crankshaft is foreshortened from the norm, and the engine output is taken from the bigger oil-pump gear instead of from the crankshaft, a natural reduction in output speed and an increase in torque can be readily achieved with the minimum physical modification to the conventional design.

Embodiments of the present invention can allow more output from a smaller package, making portability simpler. It can also reduce the noise that is generated by the output mechanism. Where it permits petrol engines to readily substitute for diesel engines it also allows strict ecological guidelines to be met by way of the usual control systems fitted to vehicular petrol engines.

Embodiments of the present invention can implement methods of efficiently and compactly reducing the output speed and increasing the torque output of an internal combustion engine. They are particularly suited to small industrial petrol engines to enable such engines to replace diesel engines as pumping or electrical generating plants. Further advantages can be found in relation to packaging, cooling and fuel economy.

An appliance made in accordance with the present invention will now be described by way of example only and with reference to the accompanying drawing, in which:

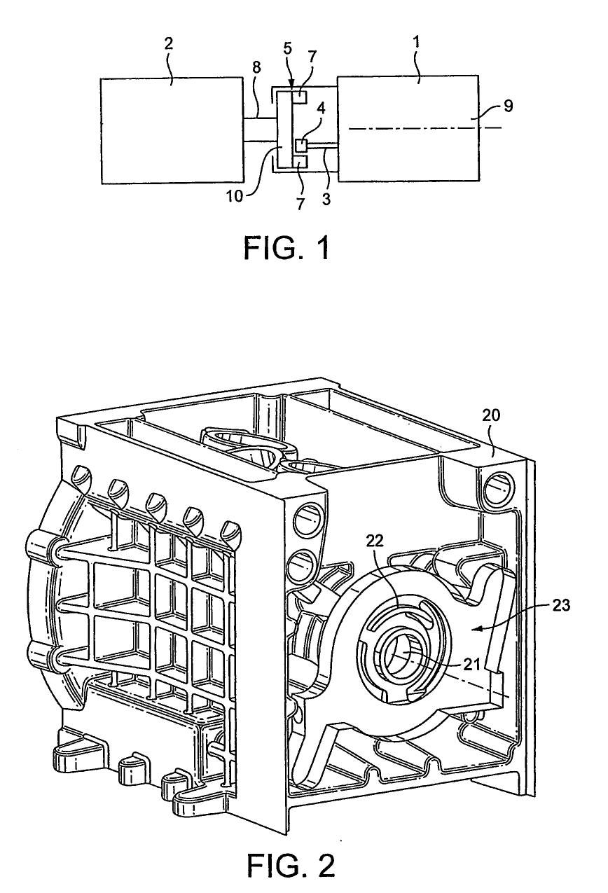

FIG. 1 shows an engine attached to a generator; and

FIG. 2 shows an engine block for an internal combustion engine.

In the system of FIG. 1 an engine 1 is connected to a generator 2. The crankshaft 3 of the engine is terminated close to the engine 1 and carries a gear 4 on its end. The gear 4 is externally toothed and meshes with the internal teeth of a larger gear 5. In this way the gear 5 can be driven to rotate by the gear 4 when the engine turns. At the point where they intermesh the gears are confined so as to allow them to act as an oil pump 6 by forcing oil trapped in pockets formed in either gear, or between the teeth of the gears, through a channel. Oil pumped in this way by the pump 6 feeds the engine 1.

The gear 5 is formed as a plate 10 having a ring 7 of internal gear teeth cut into one side. It is thus analogous to a ring gear that has a plate attached to one of its faces to close the opening of the gear on that side. The input shaft 8 of generator 2 is attached to the plate 10 concentrically with the axis of rotation of the gear 5. Thus shaft 8 is rotationally fast with gear 5, and the generator can be driven via gears 4 and 5 from the output shaft 3. The fact that the ring gear 5 is closed on its side facing away from the engine allows it to contain oil that is passing through the oil pump.

This arrangement offers a number of advantages. First, the drive to shaft 8 is at reduced speed and increased torque in comparison to the drive at shaft 3. This speed/torque alteration is achieved using the same components as provide the oil pumping for engine 1. This avoids the need for a separate gearbox and saves the space that would otherwise be occupied by such a gearbox.

A concentric pump such as pump 6 typically employs straight-cut gears. This is one of the strongest means of power transmission and (unlike helical gears) generates no end-thrust.

The package space for the oil pump is protected in all normal engines. The pump is full for at least half of its body with oil under high pressure. A suitable bleed-rate into the remainder of the pump can ensure that the entire pump is well lubricated. The oil-pump is thus inherently suited as an output gear that has minimal energy losses and requires a minimal increase in packaging space and production cost.

Furthermore, due to the concentricity the output shaft 8 can be raised closer to the internal combustion engine's true centre-line 9 than the crankshaft 3. This is a packaging advantage as most generator sets or pumps have an input directly on their own centre-line. Thus the overall height of the package is reduced.

The oil-pump capacity is naturally increased by its overall more robust diameter. This results in Improved engine lubrication and cooling also this capacity can be used to force lubricate the pump/generator bearings or cool the purpose-designed internal combustion engine, thus eliminating the need for a separate water-cooling circuit. Thus the oil driven by the pump that provides the output drive can be used to lubricate and/or cool the engine that provides the drive, and/or to lubricate and/or cool the generator or other appliance that is driven by it.

As the oil-pump body is incorporated in the end casing of the internal combustion engine the output speed of the engine can be matched to the design requirement of the driven component by selecting a suitable gear ratio for the pump. This is illustrated in FIG. 2. FIG. 2 shows an engine block 20 for an internal combustion engine. An opening 21 is provided through which the crankshaft can pass. The gear 4 (not shown in FIG. 2) runs concentrically with the crank shaft and inward of the crescent-shaped wall 22 that confines the oil within the pump in the normal way. The gear 5 (not shown In FIG. 2) runs around both the gear 4 and the crescent-shaped wall 22. The pump is thus located in a recess 23 in the end of the engine block. As indicated above, this provides a particularly space-efficient configuration.

As indicated above, this arrangement allows a petrol engine to fit in spaces where it would normally require an additional gearbox, and therefore to more readily replace a diesel engine in certain applications. A geared petrol engine can be down-sized from the equivalent direct-drive diesel due to having a greater power output; this gives a significant packaging benefit A typical petrol engine Is naturally much smoother and quieter than a typical diesel. The level of noise reduction hardware can be significantly reduced, giving further reductions in package, cost and weight.

A down-sized petrol engine, designed for single speed operation, can produce exceptional fuel economy by way of matched valve timing and high compression ratio.

A petrol engine can be adapted to run on gas with improvements in ecology and minimal loss of performance.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. An appliance set comprising:
an appliance for receiving a rotational drive at an input shaft;
an internal combustion engine having a crankshaft and an oil pump having at least one gear driven from the crankshaft; and
a coupling that mechanically couples the input shaft to the gear whereby the appliance can be driven from the gear of the oil pump.

2. The appliance set according to claim 1, wherein the gear is driven by a further gear that is rotationally fast with the crankshaft of the engine.

3. An The appliance set according to claim 2, wherein the gear is an internally toothed gear that surrounds the further gear.

4. The appliance set according to claim 3, wherein the gear and the further gear cooperate to act as the oil pump through the entrapment of oil between them.

5. The appliance set according to claim 3, wherein the axis of the gear is coincident with the axis of the input shaft.

6. The appliance set according to claim 3, wherein the axis of the gear is closer to the centre line of the engine than is the axis of the crankshaft.

7. The appliance set according to claim 1, wherein the engine is arranged to be lubricated and/or cooled by oil pumped by the oil pump.

8. The appliance set according to claim 1, wherein the appliance is arranged to be lubricated and/or cooled by oil pumped by the oil pump.

9. The appliance set according to claim 1, wherein the axis of rotation of the appliance is driven by the largest of the gears of the oil pump.

10. (canceled)
